(19) United States
(12) Patent Application Publication
(10) Pub. No.: US 2018/0259064 A1
(43) Pub. Date: Sep. 13, 2018

(54) METHOD OF RAISING ENGINE SPEED OF A VEHICLE IN RESPONSE TO A HYDRAULIC LOAD

(71) Applicant: DANA LIMITED, MAUMEE, OH (US)

(72) Inventor: T. NEIL MCLEMORE, GEORGETOWN, TX (US)

(73) Assignee: DANA LIMITED, MAUMEE, OH (US)

(21) Appl. No.: 15/761,280

(22) PCT Filed: Sep. 21, 2016
(86) PCT No.: PCT/US16/52883

§ 371 Date: Mar. 19, 2018

Related U.S. Application Data
(60) Provisional application No. 62/221,728, filed on Sep. 22, 2015.

(51) Int. Cl. F16H 59/36; F16H 15/28; F16H 61/662

(52) U.S. Cl. CPC F16H 59/36; F16H 2059/366; F16H 61/66259; F16H 15/28

(57) ABSTRACT

Described herein is a control system for a vehicle with an infinitely variable transmission (IVT) having a ball planetary variator (CVP), providing a smooth and controlled operation. In some embodiments, the vehicle is a fork lift truck. An operator commands a brake pedal, an accelerator pedal, a direction switch (or gear selector), and a hydraulic lever, which are evaluated by the control system to determine a current operating state of the vehicle. Some operating states include, forward drive, reverse drive, vehicle braking, automatic deceleration, inching, power reversal, vehicle hold, and park, among others. The control system is configured to determine a commanded engine speed based at least in part on the hydraulic lever signal.

### CROSS-REFERENCE

The present application claims the benefit of U.S. Provisional Patent Application No. 62/221,728, filed Sep. 22, 2015, which is incorporated herein by reference in its entirety.

### BACKGROUND OF THE INVENTION

Infinitely variable transmissions (IVT) and continuously variable transmissions (CVT) are becoming more in demand for a variety of vehicles as they offer performance and efficiency improvements over standard fixed gear transmissions. Certain types of IVTs and CVTs that employ ball-type continuously variable planetary (CVP) transmissions often have shift actuators coupled to the CVP for control of speed ratio during operation of the transmission. Implementation of an IVT into a vehicle such as a forklift truck can improve vehicle performance and efficiency. However, the process of controlling the ratio provided by the CVP is complicated due to the unique vehicle maneuvers known for operating a forklift truck. It is desirable for a transmission control system or more simply stated, a transmission controller to manage the IVT under all common fork lift maneuvers. Therefore a new control method is needed to control the IVT in the presence of a hydraulic accessory load on the vehicle's engine.

### SUMMARY OF THE INVENTION

Provided herein is a computer-implemented system for a vehicle having an engine coupled to an infinitely variable transmission having a ball-planetary variator (CVP), the CVP having a plurality of balls, each ball provided with a tiltable axis or rotation, each ball supported in a carrier assembly, the carrier assembly operably coupled to a shift actuator, the computer-implemented system comprising: a digital processing device comprising an operating system configured to perform executable instructions and a memory device; a computer program including instructions executable by the digital processing, the computer program comprising a transmission controller configured to manage a plurality of vehicle driving conditions; a plurality of sensors comprising: an engine speed sensor configured to sense an engine speed, and a hydraulic lever position sensor configured to sense a hydraulic lever position; wherein the transmission controller includes a driving manager sub-module and a CVP shift actuator control sub-module, wherein the transmission controller is adapted to control the engine speed based at least in part on the hydraulic lever position, and wherein the CVP shift actuator control sub-module is adapted to control the CVP. In some embodiments of the computer-implemented system, the transmission controller further comprises an input signal processing sub-module, the input signal processing sub-module configured to provide a signal indicative of the hydraulic lever position to the software module. In some embodiments of the computer-implemented system, the driving manager sub-module is configured to provide a commanded CVP speed ratio signal and a commanded engine speed signal. In some embodiments of the computer-implemented system, the transmission controller is configured to make a selection between a commanded engine speed signal and an adjusted commanded engine speed signal, the selection based at least in part on the hydraulic lever position. In some embodiments of the computer-implemented system, the CVP shift actuator control sub-module is configured to receive a commanded CVP speed ratio signal from the driving manager sub-module. In some embodiments of the computer-implemented system, the CVP shift actuator control sub-module is configured to determine a commanded CVP actuator signal based at least in part on the commanded CVP speed ratio signal, wherein the commanded CVP actuator signal is indicative of a position of the carrier assembly.

Provided herein is a computer-implemented method for controlling engine speed in a vehicle, wherein the vehicle comprises an engine coupled to an infinitely variable transmission (IVT) having a ball-planetary variator (CVP), a plurality of sensors, and a computer-implemented system comprising a digital processing device comprising an operating system configured to perform executable instructions and a memory device, and a computer program including the instructions executable by the digital processing device, wherein the computer program comprises a transmission controller; the method comprising: controlling engine speed by one or more of the plurality of sensors sensing vehicle parameters comprising: a hydraulic lever position, an accelerator pedal position, and a current engine speed; the transmission controller determining a request for an adjustment in engine speed based on the hydraulic lever position; the transmission controller controlling the engine speed based on the adjustment; and the transmission controller controlling a CVP speed ratio based on the accelerator pedal position. In some embodiments of the computer-implemented system, the transmission controller determining a commanded shift actuator position based on the CVP speed ratio.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a block diagram of a basic driveline configuration of a continuously variable transmission (CVT) used in a vehicle.

FIG. 5 is a block diagram schematic of a transmission control system that is implemented in a vehicle having a hydraulic accessory.

FIG. 6 is a flow chart depicting a process implementable in the transmission control system of FIG. 5.

### DETAILED DESCRIPTION OF THE INVENTION

A control system for a vehicle having an infinitely variable transmission (IVT) comprising a ball planetary variator (CVP), providing a smooth and controlled operation is described. In some embodiments, the vehicle is a fork lift truck. An operator commands a brake pedal, an accelerator pedal, a parking brake, a direction switch (or “gear selector”), and a set of hydraulic levers, which are evaluated by the control system to determine a current operating state of the vehicle. In some embodiments, the set of hydraulic levers could be a single hydraulic lever, an electronic switch configured to control a hydraulic system, or a set of electronic switches configured to control a hydraulic system. It should be appreciated that the use of the term “hydraulic lever” refers to any of these embodiments. Some operating states include, forward drive, reverse drive, vehicle braking, automatic deceleration, inching, power reversal, vehicle hold, and park, among others.

The electronic controller described herein is described in the context of a continuous variable transmission, such as the continuous variable transmission of the type described in U.S. Patent Application No. 62/202,415, assigned to the assignee of the present application and hereby incorporated by reference herein in its entirety. However, the electronic controller is not limited to controlling a particular type of transmission but is optionally configured to control any of several types of variable ratio transmissions.

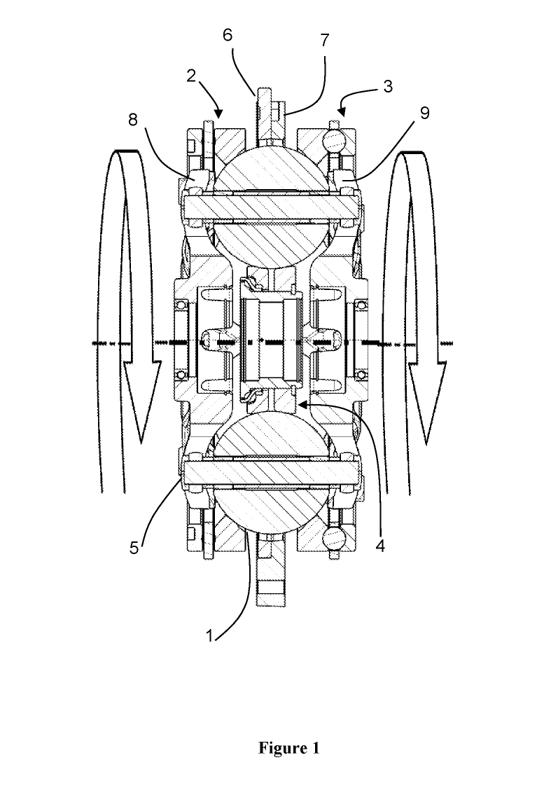

Provided herein are configurations of CVTs based on ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls, as input 2 and output 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 9 is provided with a number of radially offset guide slots 9. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first carrier member and the second carrier member to impart a tilting of the axles 5 and thereby adjusts the speed ratio of the variator. Other types of ball CVTs also exist, like the one produced by Milner, but are slightly different.

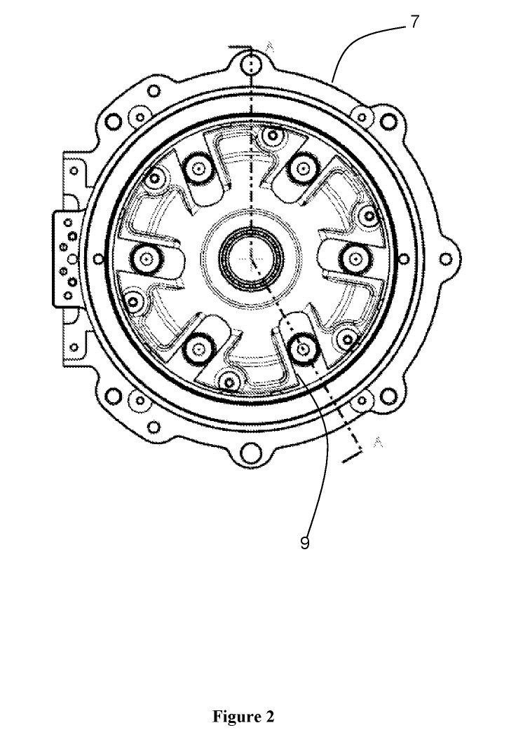

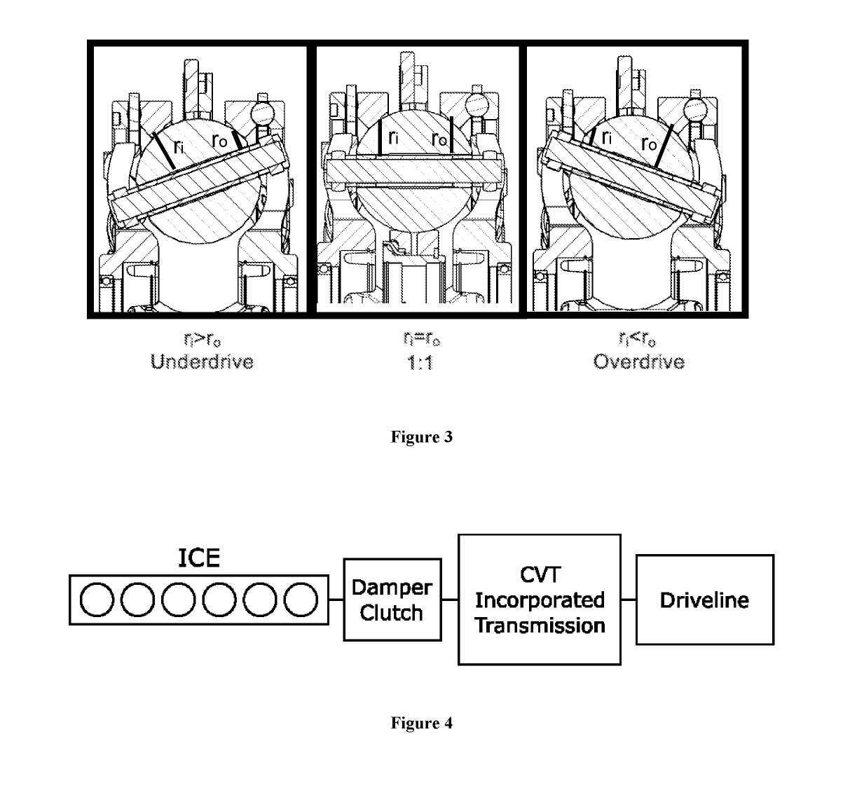

The working principle of such a CVP of FIG. 1 is shown on FIG. 2. The CVP itself works with a traction fluid. The lubricant between the ball and the conical rings acts as a solid at high pressure, transferring the power from the input ring, through the balls, to the output ring. By tilting the balls' axes, the ratio is capable of being changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments of the invention disclosed here are related to the control of a variator and/or a CVT using generally spherical planets each having a tiltable axis of rotation that is adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here may operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source may be fueled by energy sources comprising hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission comprising this technology. For description purposes, the terms “electronic control unit”, “ECU”, “Driving Control Manager System” or “DCMS” are used interchangeably herein to indicate a vehicle's electronic system that controls subsystems monitoring or commanding a series of actuators on an internal combustion engine to ensure optimal engine performance. It does this by reading values from a multitude of sensors within the engine bay, interpreting the data using multidimensional performance maps (called lookup tables), and adjusting the engine actuators accordingly. Before ECUs, air-fuel mixture, ignition timing, and idle speed were mechanically set and dynamically controlled by mechanical and pneumatic means.

For description purposes, those of skill will recognize that the terms “transmission control system”, “transmission controller,” and like terms, are used interchangeably herein to indicate electronic hardware, software stored on a computer readable medium and executable by a processor, or combinations of both for the purpose of monitoring load sensors in the vehicle and commanding the engine speed of a vehicle to increase or decrease in response to the hydraulics of that vehicle being activated or deactivated, as for example in a forklift truck.

Those of skill will recognize that brake position sensors and throttle position sensors are electronic, and in some cases, well-known potentiometer type sensors. These sensors provide a voltage or current signal that is indicative of a relative rotation and/or compression/depression of driver control pedals, for example, brake pedal and/or throttle pedal. Often, the voltage signals transmitted from the sensors are scaled. A convenient scale used in the present application as an illustrative example of one implementation of the control system uses a percentage scale 0-100%, where 0% is indicative of the lowest signal value, for example a pedal that is not compressed, and 100% is indicative of the highest signal value, for example a pedal that is fully compressed. There may be implementations of the control system where the brake pedal is effectively fully engaged with a sensor reading of 20%-100%. Likewise, a fully engaged throttle pedal may correspond to a throttle position sensor reading of 20%-100%. The sensors, and associated hardware for transmitting and calibrating the signals, can be selected in such a way as to provide a relationship between the pedal position and signal to suit a variety of implementations. Numerical values given herein are included as examples of one implementation and not intended to imply limitation to only those values. For example, a minimum detectable threshold for a brake pedal position may be 6% for a particular pedal hardware, sensor hardware, and electronic processor. Whereas an effective brake pedal engagement threshold may be 14%, and a maximum brake pedal engagement threshold are configured to begin at or about 20% compression. As a further example, a minimum detectable threshold for an accelerator pedal position may be 5% for a particular pedal hardware, sensor hardware, and electronic processor. Similar or completely different pedal compression threshold values for effective pedal engagement and maximum pedal engagement may also apply for the accelerator pedal.

As used herein, and unless otherwise specified, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 6%, 5%, 4%, 0, 2%, 1%, 0.5%, 0.1%, or 0.05% of a given value or range. In certain embodiments, the term “about” or “approximately” means within 40.0 mm, 30.0 mm, 20.0 mm, 10.0 mm 5.0 mm 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “about” or “approximately” means within 20, degrees, 15.0 degrees, 10.0 degrees, 9.0 degrees, 8.0 degrees, 7.0 degrees, 6.0 degrees, 5.0 degrees, 4.0 degrees, 3.0 degrees, 2.0 degrees, 1.0 degrees, 0.9 degrees, 0.8 degrees, 0.7 degrees, 0.6 degrees, 0.5 degrees, 0.4 degrees, 0.3 degrees, 0.2 degrees, 0.1 degrees, 0.05 degrees of a given value or range.

In certain embodiments, the term “about” or “approximately” means within 5.0 mA, 1.0 mA, 0.9 mA, 0.8 mA, 0.7 mA, 0.6 mA, 0.5 mA, 0.4 mA, 0.3 mA, 0.2 mA, 0.1 mA, 0.09 mA 0.08 mA, 0.07 mA, 0.06 mA, 0.05 mA, 0.04 mA, 0.03 mA, 0.02 mA or 0.01 mA of a given value or range.

As used herein, “about” when used in reference to a velocity of the moving object or movable substrate means variation of 1%-5%, of 5%-10%, of 10%-20%, and/or of 10%-50% (as a percent of the percentage of the velocity, or as a variation of the percentage of the velocity). For example, if the percentage of the velocity is “about 20%”, the percentage may vary 5%-10% as a percent of the percentage i.e. from 19% to 21% or from 18% to 22%; alternatively the percentage may vary 5%-10% as an absolute variation of the percentage i.e. from 15% to 25% or from 10% to 30%.

In certain embodiments, the term “about” or “approximately” means within 0.01 sec., 0.02 sec, 0.03 sec., 0.04 sec., 0.05 sec., 0.06 sec., 0.07 sec., 0.08 sec, 0.09 sec. or 0.10 sec of a given value or range. In certain embodiments, the term “about” or “approximately” means within 0.5 rpm/sec, 1.0 rpm/sec, 5.0 rpm/sec, 10.0 rpm/sec, 15.0 rpm/sec, 20.0 rpm/sec, 30 rpm/sec, 40 rpm/sec, or 50 rpm/sec of a given value or range.

Those of skill will recognize that the various illustrative logical blocks, modules, circuits, and algorithm steps described in connection with the embodiments disclosed herein, including with reference to the transmission control system/transmission controller described herein, for example, may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Software associated with such modules may reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and writes information to, the storage medium. In the alternative, the storage medium may be integral to the processor. The processor and the storage medium may reside in an ASIC. For example, in one embodiment, a controller for use of control of the IVT comprises a processor (not shown).

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Digital Processing Device

In some embodiments, the Control System for a Vehicle equipped with an infinitely variable transmission described herein includes a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media-streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments the Control System for a Vehicle equipped with an infinitely variable transmission disclosed herein includes one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the Control System for a Vehicle equipped with an infinitely variable transmission disclosed herein includes at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

Referring now to FIG. 4, in one embodiment, a vehicle is equipped with a driveline having a torsional damper between an engine and an infinitely or continuously variable transmission (CVT) to avoid transferring torque peaks and vibrations that could damage the CVT (called variator in this context as well). In some configurations this damper is optionally coupled with a clutch for the starting function or to allow the engine to be decoupled from the transmission. In other embodiments, a torque converter (not shown), is optionally used to couple the engine to the CVT or IVT. Other types of CVT's (apart from ball-type traction drives) are optionally used as the variator in this layout. In addition to the configurations above where the variator is used directly as the primary transmission, other architectures are possible. Various powerpath layouts are introduced by adding a number of gears, clutches and simple or compound planetaries. In such configurations, the overall transmission optionally provides several operating modes; a CVT, an IVT, a combined mode and so on. A control system for use in an infinitely or continuously variable transmission will now be described.

Provided herein is a computer-implemented system for a vehicle having an engine coupled to an infinitely variable transmission having a ball-planetary variator (CVP), the CVP having a plurality of balls, each ball provided with a tiltable axis or rotation, each ball supported in a carrier assembly, the carrier assembly operably coupled to a shift actuator, the computer-implemented system comprising: a digital processing device comprising an operating system configured to perform executable instructions and a memory device; a computer program including instructions executable by the digital processing device to create an application comprising a software module configured to manage a plurality of vehicle driving conditions; a plurality of sensors configured to monitor vehicle parameters comprising: engine speed, hydraulic lever position; wherein the software module is configured to execute instructions provided by a driving manager sub-module and a CVP shift actuator control sub-module, wherein the software module is adapted to determine a commanded engine speed based at least in part on the hydraulic lever position.

In some embodiments of the computer-implemented system, an input signal processing sub-module is provided, the input signal processing sub-module configured to provide a signal indicative of the hydraulic lever position to the software module.

In some embodiments of the computer-implemented system, the driving manager sub-module is configured to provide a commanded CVP speed ratio signal and the commanded engine speed signal.

In some embodiments of the computer-implemented system, the software module is configured to make a selection between the commanded engine speed signal and an adjusted commanded engine speed signal, the selection based at least in part on the hydraulic lever position.

In some embodiments of the computer-implemented system, the CVP shift actuator control sub-module is configured to receive a commanded CVP speed ratio signal from the driving manager sub-module.

In some embodiments of the computer-implemented system, the CVP shift actuator control sub-module is configured to determine a commanded CVP actuator signal based at least in part on the commanded CVP speed ratio signal, the commanded CVP actuator signal is indicative of a position of the carrier assembly.

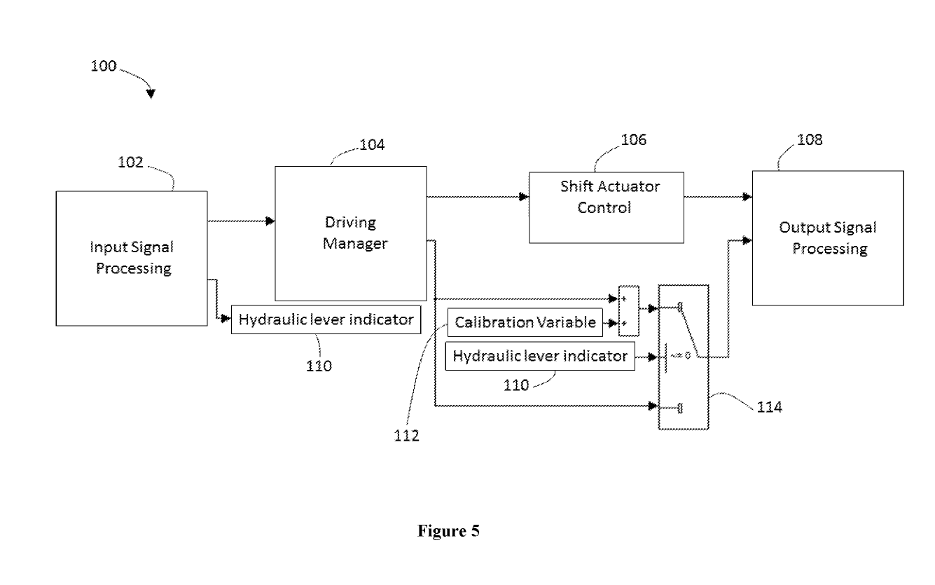

Referring now to FIG. 5, in one embodiment, a transmission controller 100 includes an input signal processing module 102. The input signal processing module 102 is adapted to receive a number of signals from sensors equipped on a vehicle equipped with the driveline depicted in FIG. 4, for example. In some embodiments, the input signal processing module 102 is adapted to receive a CAN signal from an engine control module (not shown) provided on the vehicle. The transmission controller 100 includes a driving manager module 104. The driving manager module 104 receives a number of input signals from the input signal processing module 102. The driving manager module 104 includes a number of sub-modules configured to monitor signals and execute commands during operation of the vehicle. The driving manager module 104 passes a CVP shift actuator command signal to a shift actuator control sub-module 106. The shift actuator control sub-module 106 is adapted to control the shift position of the CVP. For example, the shift actuator control sub-module 106 controls the relative position of the first carrier member 6 with respect to the second carrier member 7. The shift actuator control sub-module 106 passes a commanded CVP actuator signal to an output signal processing sub-module 108. The output signal processing sub-module 108 is adapted to communicate with actuators, controllers, and sensors equipped on the vehicle.

During operation of a vehicle equipped with the transmission controller 100, a hydraulic pump (not shown) which provides the lifting force in many fork lift trucks are driven by the engine. When the engine is operating at relatively low speeds, the hydraulic pump can only generate enough pressure to slowly raise a load. In order to increase productivity, the transmission controller 100 commands the engine speed to a higher value in response to the hydraulics being activated. This raises the pump output pressure, allowing the truck to raise a load faster.

In one embodiment, the input signal processing module 102 is adapted to provide a hydraulic lever indicator signal 110 to the transmission controller 100. The hydraulic lever indicator signal 110 is indicative of a user's command for a hydraulic accessory, for example the lifting of forks on a fork lift truck. The transmission controller 100 reads a calibration variable 112 from memory or receives the calibration variable 112 from a sub-module of the driving manager module 104. In some embodiments, the calibration variable 112 is optionally a table or calibration map configured to receive a number of signals. The calibration variable 112 is indicative of an engine speed adjustment factor. The calibration variable 112 is summed with the commanded engine speed signal determined by the driving manager module 104. A switch block 114 evaluates the hydraulic lever indicator signal 110 and passes either the commanded engine speed signal or the adjusted commanded engine speed signal to the output signal processing sub-module 108. For example, when the hydraulic lever indicator signal 110 indicates a pressed lever, a true signal is received at the switch block 114, and the switch block 114 will thereby send an adjusted engine speed signal to the output signal processing module 108. When the hydraulic lever indicated signal 110 indicates a non-pressed lever, or non-engaged lever, a false signal is received at the switch block 114, and the switch block 114 will thereby send the commanded engine speed signal determined by the driving manager module 104 to the output signal processing sub-module 108.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as any one claim makes a specified dimension, or range of thereof, a feature of the claim.

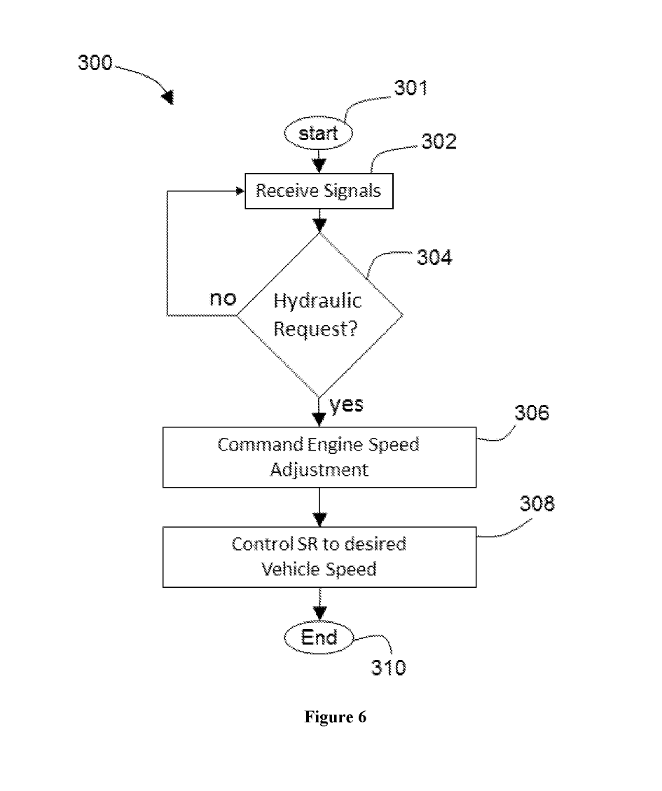

Referring now to FIG. 6, in some embodiments, a control process 300 is optionally implemented in the transmission controller 100. The control process 300 begins at a start state 301 and proceeds to a block 302 where a number of signals are received. In some embodiments, signals such as a hydraulic lever position, an engine speed, an accelerator pedal position, or a brake pedal position are received at the block 302. The control process 300 proceeds to an evaluation block 304 where a request for a hydraulic load is determined. The evaluation block 304 returns a false result when there is no indication that a user is requesting a hydraulic load on the system. The control process 300 proceeds back to the block 302 when a false result is provided by the evaluation block 304. The evaluation block 304 returns a true result when there is an indication that a user is requesting a hydraulic load. The control process 300 proceeds to a block 306 when the evaluation block 304 returns a true result. The block 306 issues a command for an engine speed adjustment to provide additional power to the hydraulic system. The control process 300 proceeds to a block 308 where commands to control the speed ratio of the transmission to maintain desired vehicle speed are sent. The control process 300 proceeds to an end state 310.

Provided herein is a computer-implemented system for a vehicle having an engine coupled to an infinitely variable transmission having a ball-planetary variator (CVP), the CVP having a plurality of balls, each ball provided with a tiltable axis or rotation, each ball supported in a carrier assembly, the carrier assembly operably coupled to a shift actuator, the computer-implemented system comprising: a digital processing device comprising an operating system configured to perform executable instructions and a memory device; a computer program including instructions executable by the digital processing, the computer program comprising a transmission controller configured to manage a plurality of vehicle driving conditions; a plurality of sensors comprising: an engine speed sensor configured to sense an engine speed, and a hydraulic lever position sensor configured to sense a hydraulic lever position; wherein the transmission controller includes a driving manager sub-module and a CVP shift actuator control sub-module, wherein the transmission controller is adapted to control the engine speed based at least in part on the hydraulic lever position, and wherein the CVP shift actuator control sub-module is adapted to control the CVP. In some embodiments of the computer-implemented system, the transmission controller further comprises an input signal processing sub-module, the input signal processing sub-module configured to provide a signal indicative of the hydraulic lever position to the software module. In some embodiments of the computer-implemented system, the driving manager sub-module is configured to provide a commanded CVP speed ratio signal and a commanded engine speed signal. In some embodiments of the computer-implemented system, the transmission controller is configured to make a selection between a commanded engine speed signal and an adjusted commanded engine speed signal, the selection based at least in part on the hydraulic lever position. In some embodiments of the computer-implemented system, the CVP shift actuator control sub-module is configured to receive a commanded CVP speed ratio signal from the driving manager sub-module. In some embodiments of the computer-implemented system, the CVP shift actuator control sub-module is configured to determine a commanded CVP actuator signal based at least in part on the commanded CVP speed ratio signal, wherein the commanded CVP actuator signal is indicative of a position of the carrier assembly.

Provided herein is a computer-implemented method for controlling engine speed in a vehicle, wherein the vehicle comprises an engine coupled to an infinitely variable transmission (IVT) having a ball-planetary variator (CVP), a plurality of sensors, and a computer-implemented system comprising a digital processing device comprising an operating system configured to perform executable instructions and a memory device, and a computer program including the instructions executable by the digital processing device, wherein the computer program comprises a transmission controller; the method comprising: controlling engine speed by one or more of the plurality of sensors sensing vehicle parameters comprising: a hydraulic lever position, an accelerator pedal position, and a current engine speed; the transmission controller determining a request for an adjustment in engine speed based on the hydraulic lever position; the transmission controller controlling the engine speed based on the adjustment; and the transmission controller controlling a CVP speed ratio based on the accelerator pedal position. In some embodiments of the computer-implemented system, the transmission controller determining a commanded shift actuator position based on the CVP speed ratio.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1-8. (canceled)

9. A method for controlling engine speed in a vehicle, wherein the vehicle comprises an engine coupled to an infinitely variable transmission (IVT) having a ball-planetary variator (CVP), a plurality of sensors, the method comprising:
receiving signals from a plurality of sensors sensing vehicle parameters including a hydraulic lever position sensor, an accelerator pedal position sensor, and a current engine speed sensor;
determining a request for a hydraulic load;
determining an adjustment in engine speed based on the hydraulic lever position; and
controlling the engine speed based on the adjustment in engine speed.

10. The method of claim 9 further comprising controlling a CVP speed ratio based on the accelerator pedal position.

11. The method of claim 10, wherein the CVP further includes a plurality of balls, each ball provided with a tiltable axis or rotation, each ball supported in a carrier assembly, the carrier assembly operably coupled to a shift actuator

12. The method of claim 11 further comprising commanding a change in the position of the shift actuator based on the CVP speed ratio.

13. The method of claim 12, wherein the carrier assembly includes a first carrier member operably coupled to a second carrier member, and wherein commanding a change in the position of the shift actuator includes controlling the relative position of the first carrier member and the second carrier member.

14. A method for controlling vehicle speed in a vehicle, wherein the vehicle comprises an engine coupled to an infinitely variable transmission (IVT) having a ball-planetary variator (CVP), a plurality of sensors, the method comprising:
receiving signals from a plurality of sensors sensing vehicle parameters including a hydraulic lever position sensor, an accelerator pedal position sensor, and a current engine speed sensor;
determining a request for a hydraulic load;
determining an adjustment in engine speed based on the hydraulic lever position; and
controlling the vehicle speed based on the adjustment in engine speed.

15. The method of claim 14, wherein controlling the vehicle speed based on the adjustment in engine speed includes controlling a CVP speed ratio to maintain a desired vehicle speed.

16. The method of claim 15, wherein the CVP further includes a plurality of balls, each ball provided with a tiltable axis or rotation, each ball supported in a carrier assembly, the carrier assembly operably coupled to a shift actuator

17. The method of claim 16 further comprising commanding a change in the position of the shift actuator based on the CVP speed ratio.

18. The method of claim 17, wherein the carrier assembly includes a first carrier member operably coupled to a second carrier member, and wherein commanding a change in the position of the shift actuator includes controlling the relative position of the first carrier member and the second carrier member.

19. The method of claim 16 further comprising selecting between the current engine speed and the adjustment in engine speed based on the hydraulic lever position.

20. The method of claim 19 further comprising commanding a change in the position of the shift actuator based on the commanded CVP speed ratio, wherein the position of the shift actuator is indicative of a position of the carrier assembly.

21. A method for controlling engine speed in a vehicle, wherein the vehicle comprises an engine coupled to an infinitely variable transmission (IVT) having a ball-planetary variator (CVP), a transmission controller and a plurality of sensors, the method comprising:
controlling engine speed by one or more of the plurality of sensors sensing vehicle parameters comprising: a hydraulic lever position, an accelerator pedal position, and a current engine speed;
determining a request for an adjustment in engine speed with the transmission controller based on the hydraulic lever position;
controlling the engine speed with the transmission controller based on the adjustment in engine speed; and
controlling a CVP speed ratio with the transmission controller based on the accelerator pedal position.

22. The method of claim 21, further comprising determining a commanded shift actuator position with the transmission controller based on the CVP speed ratio.
